(19) United States
(12) Patent Application Publication
(10) Pub. No.: US 2003/0188160 A1
(43) Pub. Date: Oct. 2, 2003

(54) Method and system to securely update files via a network

(76) Inventors: Singam Sunder, San Jose, CA (US); Jeff Edgett, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/366,071

(22) Filed: Feb. 12, 2003

Related U.S. Application Data
(63) Continuation-in-part of application No. 09/921,959, filed on Aug. 2, 2001.

(51) Int. Cl. H04L 9/00

(52) U.S. Cl. 713/165

(57) ABSTRACT

A method and system are provided of updating a client file of a client application in a multi-party access environment including a plurality of service providers. The method includes generating at least one customized client update file, the client update file being customized for a client application of at least one of a plurality of users in the multi-party environment. Thereafter a secured signature file associated with the client update file is generated and communicated with the client update file to the plurality of web servers. At various points around the globe, the secured signature file and the client file update may be downloaded to update the client application. The secured signature file may be verified before installing the client update file.

### CROSS REFERENCE TO RELATED APPLICATIONS

This application is a continuation-in-part of U.S. application Ser. No. 09/921,959, filed Aug. 2, 2001.

### FIELD OF THE INVENTION

The present invention relates to the field of remote network connections and more particularly to securely updating files via a network.

### BACKGROUND OF THE INVENTION

Due to the increasing globalization of economies and advancements in network-based communication facilities such as the Internet, there has been an increasing dependence of corporations and persons to communicate via such facilities. For example, Mobile workers (so-called “road warriors”) typically access Internet-based and wireless communications as they travel worldwide. Services that facilitate communications to such mobile persons are commonly referred to as “roaming services”.

In order utilize these roaming services, a mobile client may be provided with a customized connection application, e.g. a customized dialer, for establishing a connection to the network-based communication facility. In certain circumstances, the mobile client may require software updates and, it will be appreciated that, secure communication in these environments is particularly favorable particularly when the updates are downloaded from a public server.

For the purposes of this specification, the term “connection application” should be construed broadly as including, but not limited to, any device (both hardware and software) including functionality to authenticate data e.g., a peer-to-peer authentication arrangement, a dialer, a smart client, a browser, a supplicant, a smart card, a token card, a PDA connection application, a wireless connection, an embedded authentication client, an Ethernet connection, or the like.

### SUMMARY OF THE INVENTION

According to one aspect of the invention, there is provided a method and system to securely update files via a network.

Other features of the present invention will be apparent from the accompanying drawings and from the detailed description that follows.

### BRIEF DESCRIPTION OF THE DRAWINGS

The present invention is illustrated by way of example, and not limitation, with reference to the accompanying diagrammatic drawings, in which like references indicate the same or similar features unless otherwise indicated.

In the drawings,

FIG. 1A is a diagram of centralized customization system architecture according to one embodiment of the present invention;

FIG. 1B is a block diagram illustrating domains of a data model utilized by a customization tool and a phonebook generation tool of the customization system, according to one embodiment of the present invention;

FIG. 2 is a flow diagram illustrating operation of a back-end of a centralized customization system according to one embodiment of the present invention;

FIGS. 3A and 3B are flow diagrams illustrating a customization process of building a customized dialer according to one embodiment of the present invention;

FIG. 4 is a graphical end-user interface presented to a customer to allow the selection of a customer account according to one embodiment of the present invention;

FIG. 5 is a graphical end-user interface presented to the customer to create or edit a dialer profile according to one embodiment of the present invention;

FIG. 6 is a graphical end-user interface presented to the customer to allow an input of basic settings according to one embodiment of the present invention;

FIGS. 7A and 7B show graphical end-user interfaces presented to the customer to allow addition of a logo to the customized dialer according to one embodiment of the present invention;

FIG. 8 is a graphical user-interface presented to the customer to allow specification of dialer connection actions according to one embodiment of the present invention;

FIG. 9 is a graphical user-interface presented to the customer to allow addition of customer POPs to a dialer phonebook according to one embodiment of the present invention;

FIG. 10 is a graphical user-interface presented to the customer to allow making of the dialer phonebook according to one embodiment of the present invention;

FIG. 11 is a graphical user-interface presented to the customer to allow specification of POP filter rules according to one embodiment of the present invention;

FIG. 12 is a graphical user-interface presented to the customer to allow specification of pricing rules according to one embodiment of the present invention;

FIG. 13 is a graphical user-interface presented to the customer to allow review of customized information according to one embodiment of the present invention;

FIG. 14 is a graphical user-interface presented to the customer to allow downloading of files according to one embodiment of the present invention;

FIG. 15 is a flow chart detailing a phonebook generation process performed by a phonebook generation tool;

FIG. 16 is a diagram of system architecture according to one embodiment of the present invention;

FIG. 17 is a graphical end-user interface presented on a client machine that constitutes a main dialog box of a dialer according to one embodiment of the present invention;

FIG. 18 is a graphical end-user interface presented on the client machine that allows an end-user to specify dial properties according to one embodiment of the present invention;

FIG. 19 is a graphical end-user interface presented on the client machine that prompts the end-user for end-user information according to one embodiment of the present invention;

FIG. 20 is a graphical end-user interface presented on the client machine that allows the end-user to specify settings of the dialer according to one embodiment of the present invention;

FIGS. 21 and 22 show graphical end-user interfaces presented on the client machine that allows the end-user to add and modify bookmarks according to one embodiment of the present invention;

FIG. 23 is a diagrammatic representation of a number of exemplary protocols and/or components that may be utilized to support various access methods that may be performed utilizing a network connection application, according to exemplary embodiments of the present invention;

FIG. 24 is a diagram of exemplary system architecture, according to one embodiment of the present invention, wherein a web server for generating a connect application and its components are located behind a firewall;

FIG. 25 is a schematic flow diagram of an exemplary method, in accordance with one embodiment of the invention, for securely updating files of a connection application;

FIG. 26 is a schematic flow diagram of an exemplary method, in accordance with one embodiment of the invention, for updating client files on a client machine;

FIG. 27 is a schematic flow diagram of an exemplary method, in accordance with one embodiment of the invention, for generating a signature file for verifying an update file;

FIG. 28 is a schematic flow diagram of an exemplary signature file verification process on a client machine;

FIG. 29 is a schematic diagram showing a scenario in which multiple key pairs are active in a network environment;

FIG. 30 is a schematic flow diagram of an exemplary method, in accordance with one embodiment of the invention, for updating a public key; and

FIG. 31 is a diagrammatic representation of a machine, in an exemplary form of a computer system, for executing a sequence of instructions stored on a machine-readable medium, the sequence of instructions causing the machine to perform any of the methodologies described herein.

### DETAILED DESCRIPTION

Although the present invention is described below by way of various embodiments that include specific structures and methods, embodiments that include alternative structures and methods may be employed without departing from the principles of the invention described herein.

In general, embodiments described below feature a system and a method that facilitate updating of a customized network connection application (e.g., a dialer) to serve the needs of a given customer. A preferred embodiment of the present invention features a centralized network dialer customization system.

Network-Related Technology

Before describing embodiments of the present invention in detail, it may be helpful to discuss some of the concepts on which the present invention is based. A component of one embodiment of the present invention is a computer server. Servers are computer programs that provide some service to other programs, called clients. A client and server communicate by means of message passing often over a network, and use some protocol, (i.e., a set of formal rules describing how to transmit data), to encode the client's requests and/or responses and the server's responses and/or requests. The server may run continually waiting for client's requests and/or responses to arrive or it may be invoked by some higher level continually running server that controls a number of specific servers. Client-server communication is analogous to a customer (client) sending an order (request) on an order form to a supplier (server) dispatching the goods and an invoice (response). The order form and invoice are part of the protocol used to communicate in this case.

Another component of one embodiment of the present invention is Microsoft Foundation Class (MFC), a collection of software structures written in C++ language and which are Microsoft Windows-based classes and which can respond to messages, make windows, and from which application specific classes can be derived. The current invention also utilizes the Remote Access Service (RAS) API, which provides an abstraction layer between the application and the underlying hardware that provides the Point-To-Point Protocol (PPP) connection. RAS is a feature built into Windows NT that enables users to log into an NT-based Local Area Network (LAN) using a modem, X.25 connection or Wide Area Network (WAN) link. RAS works with several major network protocols, including TCP/IP, IPX, and Netbeui.

Another component of one embodiment of the present invention is a Point-to-Point Tunnel Protocol (PPTP), a new technology for creating Virtual Private Networks (VPN), developed jointly by Microsoft Corporation, U.S. Robotics and several remote access vendor companies, known collectively as the PPTP forum. A VPN is a private network of computers that uses the public Internet to network processing locations. Because the Internet is essentially an open network, PPTP is used to ensure that messages transmitted from one VPN node to another are secure.

Yet, another component of one embodiment of the present invention is a Telephony Application Programming Interface (TAPI), an Application Programming Interface (API) for connecting personal computers running Windows operating system to telephone services. TAPI was introduced in 1993 as the result of joint development by Microsoft Corporation and Intel Corporation. The standard supports connections by individual computers as well as Local Area Networks (LAN) connections serving many computers. Within each connection type, TAPI defines standards for simple call control and for manipulating call content.

Another component of one embodiment the present invention is an Internet Service Provider (ISP). An ISP is a service that provides access to the Internet. For a monthly fee, a service provider gives a customer a software package, username, password and Internet access phone number. Equipped with a modem (e.g., a dial-up, DSL, ISDN or wireless), a customer can then log onto the Internet and browse the World Wide Web (WWW) and USENET, send and receive e-mail, and access a particular network. In addition to serving individuals, ISPs also serve large companies, providing a direct connection from the company's networks to the Internet. ISPs themselves are connected to one another through Network Access Points (NAPs). NAP is a public network exchange facility where ISPs can connect with one another in peering arrangements. The NAPs are a key component of the Internet backbone because the connections within them determine how traffic is routed. They are also the points of most Internet congestion.

ISPs generally provide a plurality of Point of Presence gateways (POP) in order for a customer to gain an Internet access by making a local call. A POP (point-of-presence) is an access point to the Internet that is associated with a phone number. A connection established via such a POP causes a unique IP address to be assigned to a machine that accesses the Internet utilizing the established connection. The number of POPs that an ISP has and the number of subscribers are usually used as a measure of its size or growth rate.

Yet another component in one embodiment of the present invention is a servlet. Servlets are Java applications, which run on a Web server or application server and provide server-side processing, typically to access a database. It is a Java-based alternative to Common Gateway Interface (CGI) scripts, interface programs, usually written in C or PERL, which enables an Internet server to run external programs to perform a specific function. The most important difference between servlets and CGI scripts is that a Java servlet is persistent. This means that once it is started, it stays in memory and can fulfill multiple requests. In contrast, a CGI script disappears once it has fulfilled a request.

Architecture

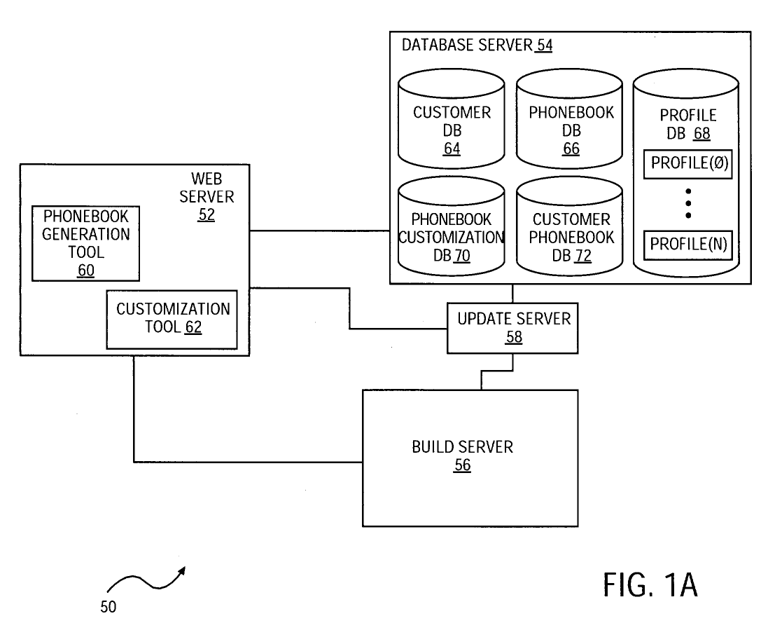

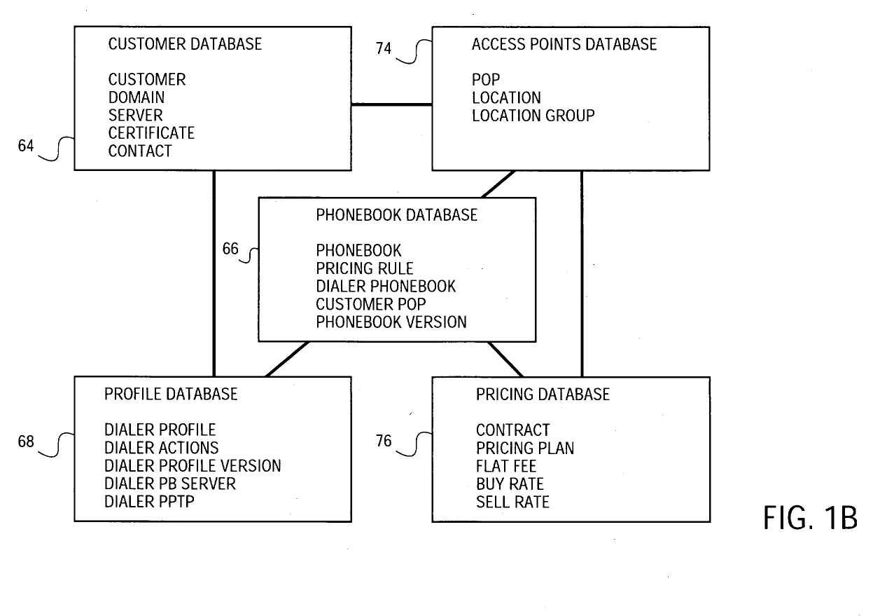

With these concepts in mind, an embodiment of system architecture of the present invention can be explored. In one embodiment, the present invention includes customization system and an end-user tool that allows a user to establish a network connection. FIG. 1A illustrates an exemplary customization system 50 that includes a web server 52, database server 54, a build server 56, and an update server 58. The web server 52 contains a phonebook generation tool 60, responsible for phonebook generation update and customization, and a customization tool 62, responsible for customization of a dialer application (hereinafter “the dialer”). While the exemplary embodiment of the present invention describes the generation, distribution and updating of a customized dialer, it will be appreciated that the dialer is merely an example of a connection application with purposes of establishing a connection between a client and a server computer, or between peer computers within a network. Accordingly, the present invention should not be construed as being limited to the generation, distribution and updating of an application for establishing a dialed connection over the Public Switched Telephone Network (PSTN), and extends to the generation, distribution and updating of any customized connection application that operates to establish a connection between machines coupled via a network.

The database server 54 contains a customer database 64, a phonebook database 66, a profile database 68, a phonebook customization database 70, and a customer phonebook database 72. It will be appreciated that databases may not be stored at the server machine and the database data may be uploaded to the server machine when necessary.

FIG. 1B is a diagrammatic representation of domains of a data model accessed and maintained by the phonebook generation tool 60 and the customization tool 62, according to an exemplary embodiment of the present invention. Specifically, the data model is shown to include the primary components of the customer database 64, the phonebook database 66, and the profile database 68. The data model is also shown to include an access points database 74, and a pricing database 76, which will be described in further detail below.

Methodology

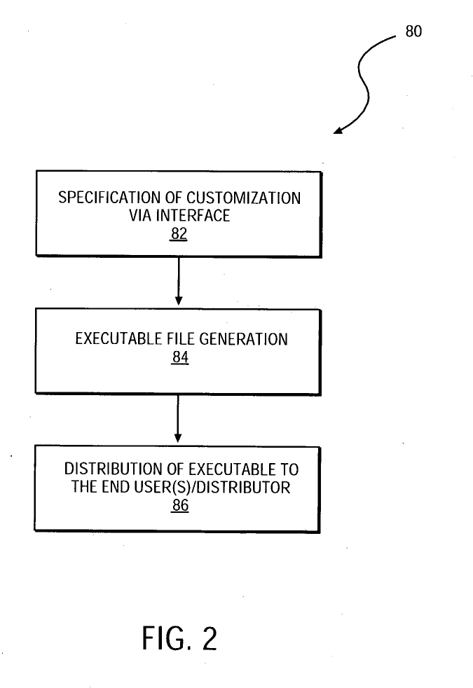

A flow chart showing a method 80, according to an exemplary embodiment of the present invention, of generating and distributing a customized dialer is illustrated in FIG. 2. At block 82 the customization occurs, during which the customer utilizing, in one embodiment, a series of web pages, generated by the web server 52, specifies information (or parameters) for the customization of a dialer that will incorporate the customer's needs. At block 84 of FIG. 2, generation of an executable file takes place upon the customer completing the customization process. The executable file is generated by the build server 56, the description of which follows. At block 86 the distribution of the executable file to the end-users or to the distributor, which in turn distributes it to the end-users, takes place. The above-mentioned back-end processes of the method 80 are described in detail below.

Methodology: Customization by Customization Tool

In one exemplary embodiment, the customization tool 62 is a web application developed utilizing HTML, JavaScript, and JavaServlets.

The customization tool 62 presents a customer of the system 50 with a sequence of web pages that guide the customer through a process of building a customized dialer incorporating the customer's needs. The output of the customization process implemented by the customization tool 62 is a “profile” that defines a customization of a network connection application. Utilizing the customization process, a customer may define multiple customized network connection applications (e.g., dialers), each customized network connection application being described in terms of a profile.

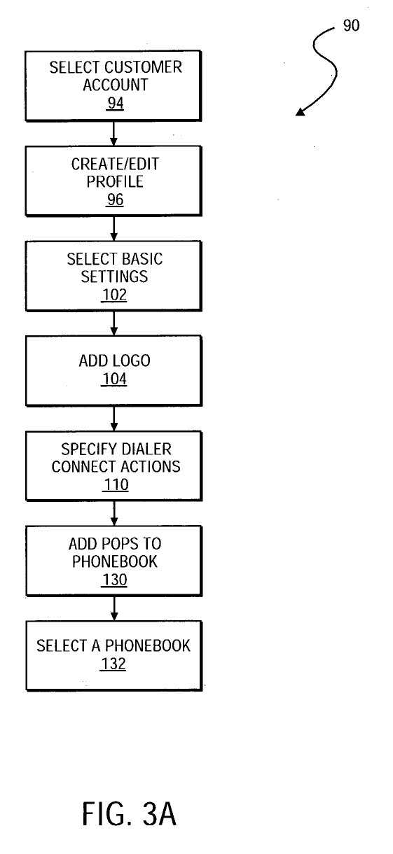

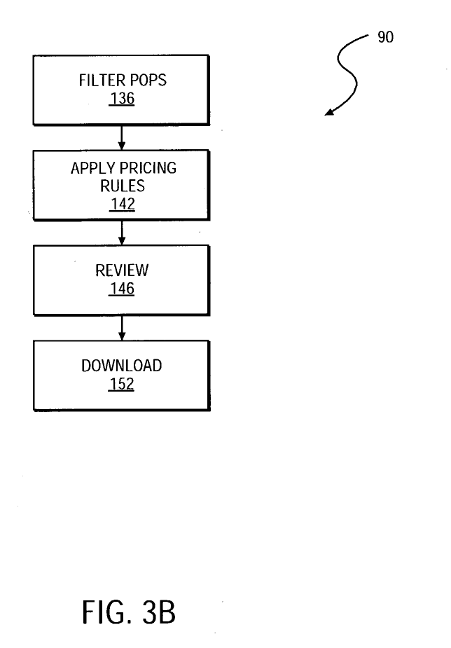

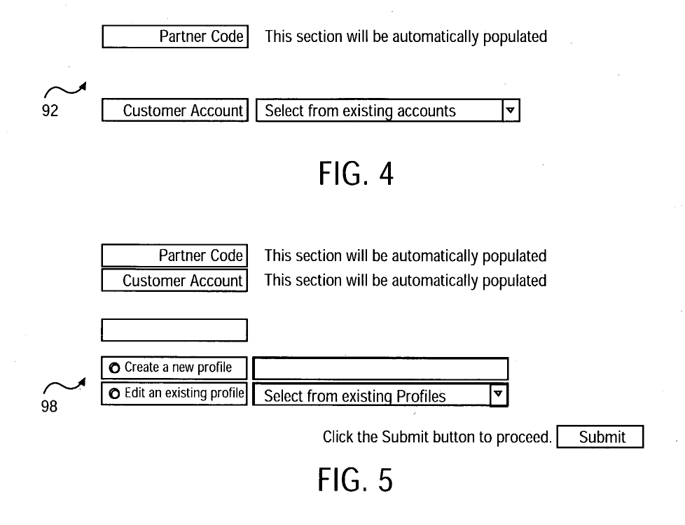

An exemplary embodiment of a customization process 90, implemented by the customization tool 62, is described with the reference to FIG. 3A and FIG. 3B. Upon the customer logging onto the customization system 50, the customer is presented with a sequence of web pages, generated by the web server 52 that facilitate the input of customization information specifying preferences of the customer. A first customization page 92, an example of which is illustrated in FIG. 4, is generated and presented at block 94. The page 92 prompts the customer to select a customer account name under which all the customization information is stored. A partner code, representing an account number, may be automatically displayed after the customer login process. More specifically, the page 92 is utilized only for “channel” customers of a primary customer. The selected customer account name is a coded name for the channel customer for which a customer's dialer is to be generated, and the customization system 50 stores all customization information entered during the process 90 under the relevant customer account name.

At block 96 the second web page 98, an example of which is illustrated in FIG. 5, is presented to the customer where the customer is prompted to select between the options of creating a new profile, or editing an existing profile.

A profile consists of all the files needed by the customization system 50 to create a complete, self-installing package distributable to a customer of the system 50, a distributor or directly to a customer's end-users. Customers may maximize or minimize the identification of the service or organization depending on what is included in a dialer profile. For example, the following features that are described in detail below may be included into a dialer profile: custom corporate logos, connection actions, addition and removal of access points (POPs), and pricing setting.

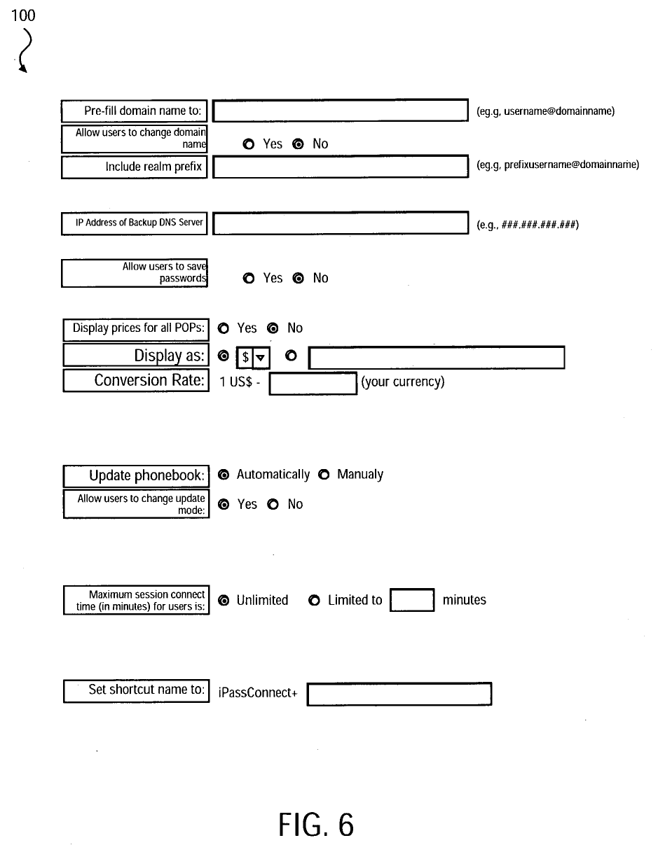

The customer is presented with the third web page 100, an example of which is illustrated in FIG. 6, at block 102 giving the customer an option to enter a default authentication domain, which will allow the end-users to enter only a end-user name and password in order to be connected to the network, without specifying a domain name. At the third web page 100, the customer may be prompted for the back-up Domain Name System (DNS) server IP address. The back-up DNS server may be used where a Point-of-Presence (POP), which an end-user has dialed into, does not automatically assign an IP address. In one embodiment of the present invention all POPs in the phonebook database 66 have dynamic DNS addressing. The customer may specify if he/she desires the end-users to have an option of saving their password in order to avoid entering it every time an end-user logs into the system.

The third web page 100 may also prompt the customer to specify if prices will be displayed next to each dial-in number when the dialer is invoked by the end-user. The customer may also desire to display prices in particular currencies. According to one embodiment of the present invention, the customer may enter a conversion rate in order for the dialer to display pricing in currency applicable to the end-users' geographical location.

Phonebook updates are uploaded to the end-user's machine upon establishment of a network connection through the dialer. The customer may, via the third web page 100, specify if it desires the end-users to choose a manual phonebook update instead of an automatic one.

Some customers may desire to limit network connection sessions of the end-users. The third web page 100 allows customers to specify the maximum connect time that the customer desires the end-users to have. In one embodiment, an unlimited option may be available for the customers to select.

In one embodiment of the present invention the dialer will be installed on end-users' machines with a default shortcut name. Via the third web page 100, the customer may specify its own shortcut name, for example, the name of the company.

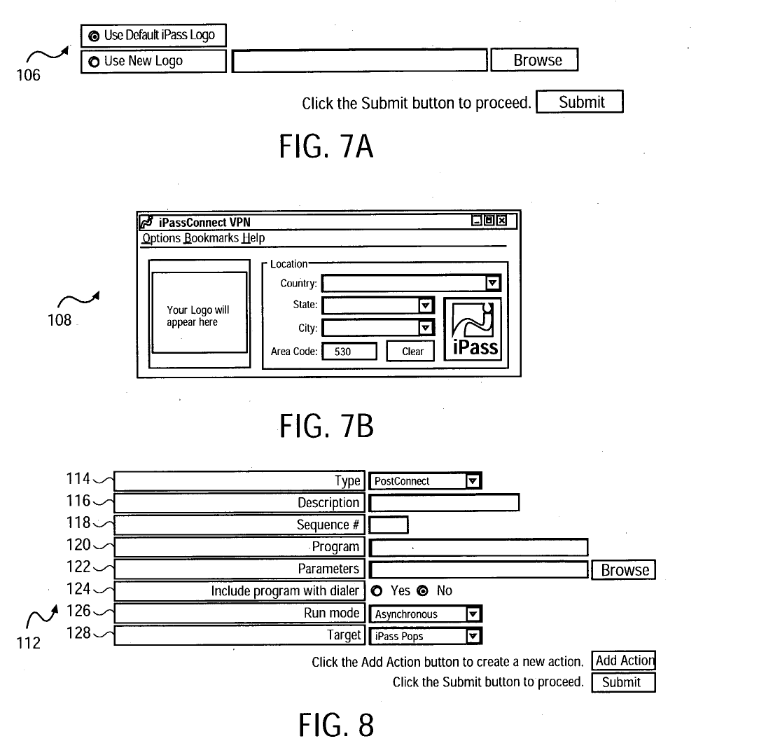

Upon selection of the options displayed at the third web page 100, the customer at block 104 is presented with the fourth web page 106, an example of which is illustrated in FIG. 7A, allowing the customer to add a personalized logo to the dialer application distributed to the end-users.

FIG. 7B illustrates an exemplary end-user interface 108, generated by a dialer, that displays a selected logo to an end-user when the dialer is invoked.

In one embodiment, at block 110 the customer is presented with a fourth web page 112, an example of which is illustrated in FIG. 8, allowing the customer to specify the dialer connect actions. Dialer connect actions are additional programs that may be executed at various points when the end-users connect to the Internet utilizing the customized dialer. For example, a connect action may be an automatic establishment of a VPN connection after the end-user connects to the Internet. According to one embodiment of the present invention, the customer may specify connect actions to execute at six different points during the end-user's connection process. Those actions may be a PostConnect action specifying programs to be executed after the connection is established; a PreConnect action specifying programs to execute prior to the establishment of the network connection; a PreDial action specifying programs to run immediately prior to dialing a point of access number; an OnError action specifying programs to run in case an error occurs; an OnCancel action specifying programs to run when the end-user decides to cancel a connection session; and Disconnect action specifying programs to run when the end-user disconnects from the Internet.

In box 114 of FIG. 8 the customer is presented with a drop-down menu to select an action type from the list described above to be added to a dialer profile. A description box 116 allows the customer to enter a short description of the programs that the customer wants to be executed. In box 118 the customer may specify the sequence in which the connect action to be executed. In a case where the connect actions are asynchronous, or there is only one action, the sequence of execution is not important. In box 120 the customer may specify the name of the program to be launched at a particular connect action. The customer is presented with a browse feature in order to specify the exact name of the program. The customer may specify the parameters, including the command line parameters, necessary to run the program in box 120. In box 124 the customer may specify that a program does not need to be loaded with the dialer to the end-users' machines. In one embodiment, the programs that need to be run at particular connect actions may be already installed on the end-users' machines. In one embodiment, the customers may select a sequence of connect action to run at the same time (asynchronous mode), or one after the other (synchronous mode) in box 126. If the programs are running in synchronous mode, one program must completely finish executing before the next one can be launched in synchronous mode. In one embodiment if an error occurred while executing one of the programs, the connect action to be executed after the program may not be launched. In box 128, the customer may identify the POPs for which the connect actions should run. In one embodiment, the customer is presented with an option to create additional connect actions or to delete the existing ones.

In one embodiment of the present invention, the customized dialer may be configured to launch Microsoft's VPN (PPTP) after a successful connection is established. PPTP support may be built into the customized dialer and not require any additional client software.

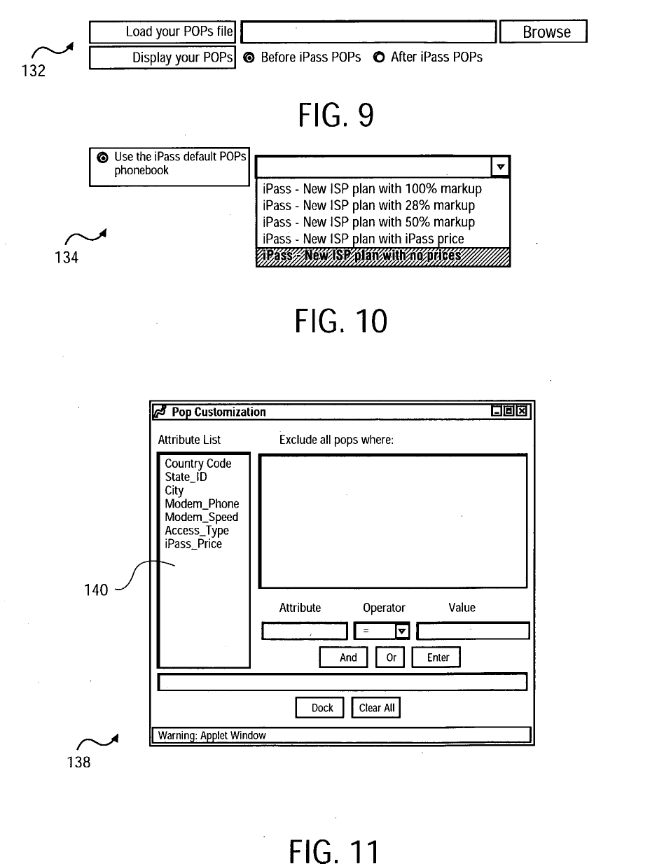

Returning to FIG. 3A, in block 130 the customer may add POPs to a phonebook, stored in the phonebook database 66, utilizing a sixth web page 132, an example of which is illustrated in FIG. 9. In one embodiment, the list of POPs to be added to the phonebook may be created through a text editor. Each POP to be added may be identified by the following parameters: a country code that may be represented in a 2-letter code; the POP's region identification number or state identification number; the city in which the POP is located; the area code of the phone number for the POP; the phone number for the POP, without the area code; the maximum analog speed supported by the POP; identification of whether one channel or two channel ISDN is available or if no ISDN is available for the POP to be added; identification of whether Password Authentication Protocol (PAP) is available; identification of whether Challenge Handshake Authentication Protocol (CHAP) is available; the price to be charged for the utilization of the POP; the prefix used for routing the authentication request; the suffix to be used for routing the authentication request; a script name of a file containing a series of commands, parameters and expressions required to establish the connection via the POP.

At block 132 of FIG. 3A, the tool 62 presents a list of phonebooks that are valid for the customer as per the pricing plan associated to the customer. The list of phonebooks may be presented via a drop-down menu of a web page 134, an example of which is illustrated in FIG. 10. These phonebooks contain all the POPs in a service provider network, excluding the POPs filtered as per the filtering value associated to the pricing plan. The customer can further apply custom filtering and pricing rules to the phonebooks to arrive at their customized phonebooks. For some plans, the tool 60 may generate phonebooks that have price markups. The example web page 134, shown in FIG. 10, provides examples of such markups. At block 136 the customer is presented with an eighth web page 138, an example of which is illustrated in FIG. 11, through which the customer may specify filter rules for various POPs. In box 140 the customer is presented with a list of the attributes that may be used in filtering the list of POPs presented to the end-users. In one embodiment, the filter rules may be the Structures Query Language (SQL) where clauses. The filtering rules may be generated utilizing a list of the attributes including, but not limited to: country code; the region or state identification of a POP; the city in which the POP is located; the phone number of the POP without an area code; the maximum analog speed supported by the POP; the price of the POP; identification if one channel or two channel ISDN is available or if no ISDN is available for the POP to be added. For example, in order to filter all POPs located in the Russian Federation, a filter rule may specify: Country Code=‘RU’, where ‘RU’ is the 2-letter code for the Russian Federation.

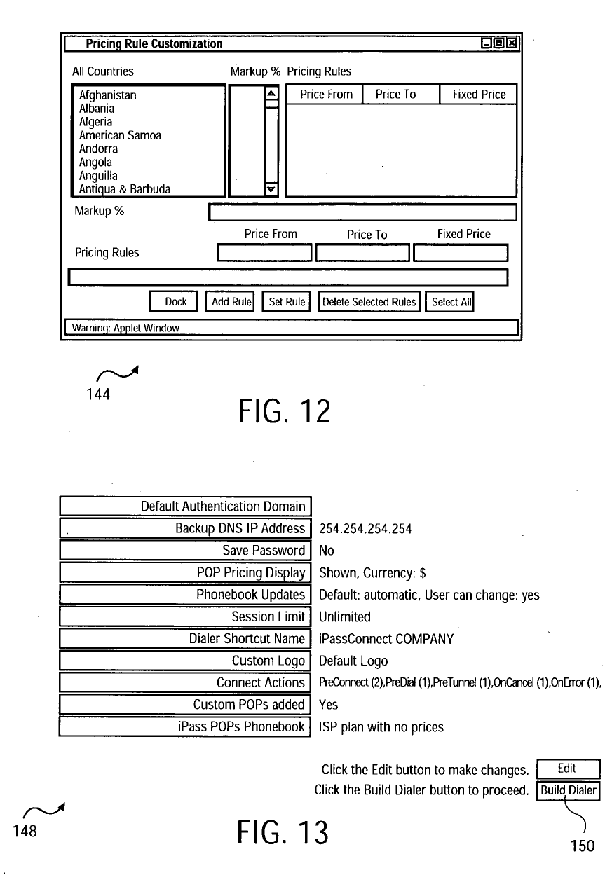

At block 142 the customer is presented with a ninth web page 144, an example of which is illustrated in FIG. 12, that allows the customer to specify pricing rules to be applied to the prices of the POPs in the customization system phonebook. Two types of the pricing rules may be available to the customer according to one embodiment of the present invention: the percentage markup or slab pricing. If percentage markup pricing is selected, the system 50 applies a specified markup percentage to the POP price listed in the customization system phonebook. The slab pricing applies a pricing formula specified by the customer to the listed prices in the customization system phonebook. For example, the customer may specify a particular amount to be added to a listed POP price if the listed price is within the customer-specified price range and a different amount to be added if the listed price is outside the customer-specified range. In one embodiment, the customer may also specify different rules for the POPs currently listed in the phonebook and the POPs that are going to be added to the phonebook in the future. In another embodiment of the present invention, the customer may specify different pricing rules for different countries.

At block 146 of FIG. 3B the customer is presented with a review web page 148, an example of which is illustrated in FIG. 13, that shows the details of the customization process that was performed by the customer. If the customer is not satisfied with the details he or she may edit a dialer profile to make desired changes to the customization. If the customer is satisfied with the dialer profile he/she may click on the Build Dialer button 150 in order to build a dialer according to the customer-specified customization information. Upon the customer requesting to build the customized dialer, the customization information is sent to the build server 56. The build server 56 generates a self-extracting (or self-installing) executable file that is capable of being distributed to the customer, a specified distributor or directly to the customer's end-users in order to provide the end-users with the Internet access through the customized dialer. In one embodiment of the present inventions upon the end-users connection to the system 50 utilizing the dialer, the build server 56 dynamically adds new files and removes outdated files utilizing the version numbers associated with each file and dynamically generates a self-extracting executable that replaces an outdated end-user's dialer file. This update process is described in more detail below.

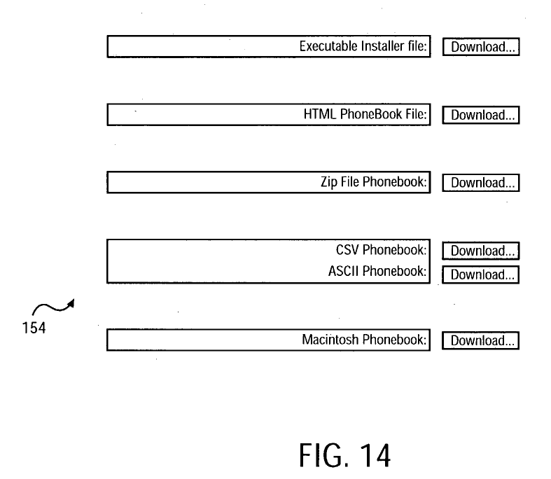

At block 152 the customer is presented with the download web page 154, an example of which is illustrated in FIG. 14. The web page 154 contains the list of files that are necessary to publish the customized dialer to the end users. In one embodiment those files are executable installation file generated by the build server 56, a phonebook file containing all the POPs in the customized phonebook, a zip phonebook file containing Perl scripts and data files necessary to generate smaller HTML files per each country, a phonebook file containing phonebooks in CSV and ASCII format and a Macintosh phonebook file which is in a format compatible with the Macintosh dialers.

In one embodiment, the customization system 50 utilizes the pricing and access point data maintained by a settlement system that described in detail in a co-pending patent application Ser. No. 09/791,239, titled “A Method and System to Facilitate Financial Settlement of Service Access Between Multiple Parties”. The pricing data maintained by the settlement system specifies the method of pricing of a POP according to a particular pricing plan. The customization system 50, in one embodiment, retrieves a contract of a customer and the list of available phonebooks for the retrieved customer pricing plan.

In one embodiment, the customer may specify the rules for the termination of a connection if it is determined to be idle. The decision to terminate the connection may depend on the specified allowed duration of the idle connection before its termination, on the allowed minimum data transfer rate before the connection is terminated (this may be used to discount certain background traffic, which does not represent real end-user activity), on the allowed time to respond to a dialog box to renew the connection by the end-user before the connection is terminated. In one embodiment the absolute limit may be set on the length of sessions, regardless of the connection activity as described above.

In one embodiment of the present invention, the customer may require the customized dialer to support foreign languages through the use of external language resources and help files. In one embodiment at runtime, the customized dialer may determine the language of the operating system installed on the end-user's machine and load the associated language resource and help files stored at the end-user's machine. If external files are not found, the customized dialer may use the default language, i.e. English.

In one embodiment security information, such as end-user password, VPN password, calling card PIN, stored locally on the end-user's system may be encrypted using standard encryption algorithms well know in the art.

It will be appreciated that the above-described customization process need not be implemented utilizing a series of web pages. In one embodiment the customization may be performed through a software application and the customization information may then be uploaded to the centralized customization tool through a network.

Methodology—Update

In one embodiment of the present invention, the customization tool 62 updates multiple copies of a network connection application (e.g., a dialer) distributed by the customer to the end-users automatically upon each end-user connecting to a network access point. In an alternative embodiment, an end-user may manually invoke the update feature of the customized dialer distributed to him/her by the customer. During the update process, the client dialer contacts the update server 58 and retrieves the list of files and their latest version numbers. The dialer compares the list of files stored locally with the list retrieved from the update server 58. If the list and/or the version numbers don't match, the dialer retrieves the affected files from the update server 58. In one embodiment of the present invention, the new build executable and DLL files are downloaded to the client machine and stored in temporary locations due to inefficiency of updating dialer files when the dialer is running. Upon the end-user exiting the dialer, the files on the client machine are updated to the files containing newer information.

In one embodiment the customer may not want the end-users to have access to the latest changes until, for example, the testing of all the new POPs is performed. In such a case the customer may instruct the customization system 50 not to update the dialer automatically unless instructed otherwise.

Methodology: Phonebook Generation

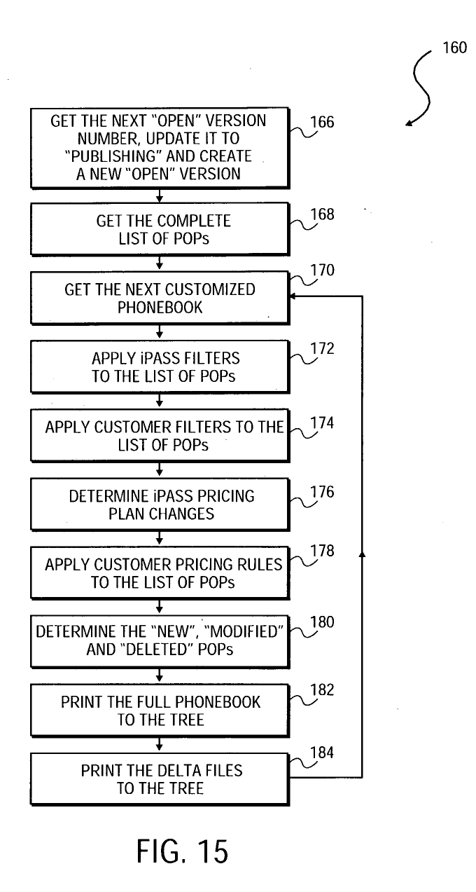

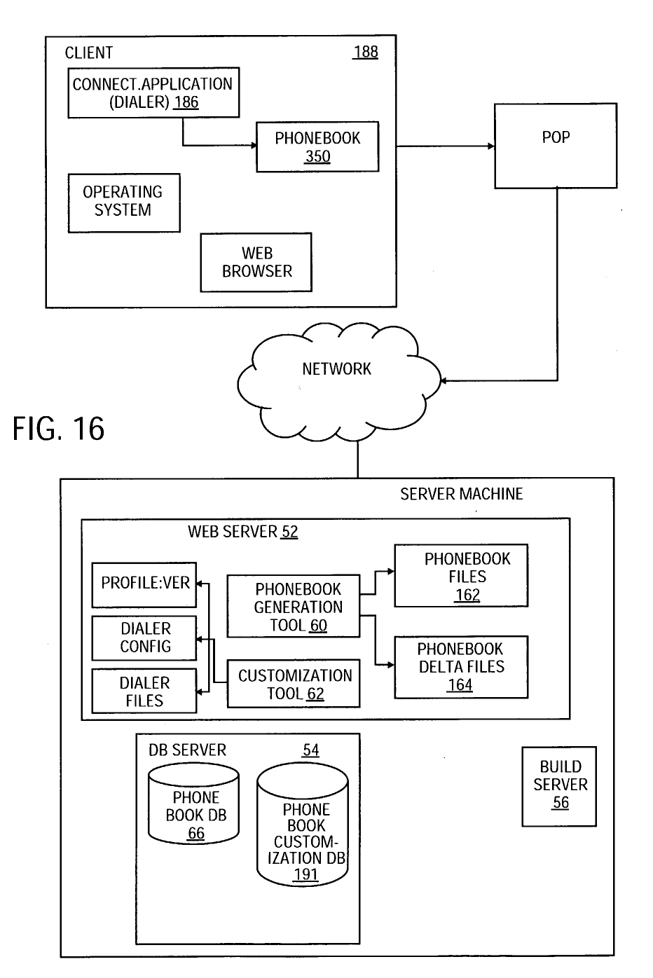

FIG. 15 is a flow chart illustrating a method 160, according to an exemplary embodiment of the present invention, that is performed by the phonebook generation tool 60 to create a phonebook and phonebook delta files 162 and 164, illustrated in FIG. 16. In one embodiment, the phonebook generation tool 60 is a Java application that uses a database to store and manipulate phonebook data. The tool 60 may communicate with the database utilizing the JDBC protocol. The tool 60 furthermore publishes the generated phonebook and phonebook delta files 162 and 164 to the file system on the web server 52 for publication.

The generated phonebook files 162 may be customized according to the needs of a customer, (e.g., a particular POPs may be filtered or removed, and rules may be established for the pricing of POPs).

A phonebook management system (not shown) maintains a current “open” phonebook version number and tags changes with this version number. Each run of the phonebook generation tool 60 increases this phonebook version by one. When the phonebook generation tool 60 runs, it closes the current “open” phonebook version number, and opens a new “open” phonebook version. All subsequent changes to the phonebook database are tagged with the new “open” phonebook version number.

The phonebook generation tool 60 determines changes to the phonebook database since the last run of the tool 60, and generates phonebook and phonebook delta files 162 and 164. A more detailed description will now be provided with reference to FIG. 15.

In one embodiment, the phonebook generation tool 60 generates delta files that contain cumulative changes to the phonebook database 130 since the last version of the phonebooks was published. In one embodiment if the size of the delta files is greater than 75% of the size of the whole phonebook, the delta files are not generated.

Referring to FIG. 15, at block 166 the phonebook generation tool 60 creates the next open version phonebook number and updates the current phonebook version to publishing and creates a new open version phonebook. At block 168, the phonebook generation tool 60 retrieves the complete list of POPs from the server. Upon retrieval of the complete POP list the phonebook generation tool 60 at block 170 retrieves the latest customized phonebook. Application of the default filters to the list of POPs (for example, customer location filters) occurs at block 172. At block 174 the phonebook generation tool 60 applies customer-specified filters to the list of POPs (e.g., eliminates some of the countries that the customer specifically requested to be excluded from the available POPs). At block 176 the phonebook generation tool 60 determines if the pricing plans for particular POPs have changed. If positive then the necessary corrections are made to the list of POPs. In some instances the customer may specify his/her own pricing rules, for example, to charge end-users 10% more than the price iPass charges the customer. These customer pricing rules are applied at block 178. Upon application of the above-described rules, the phonebook generation tool 60 determines the new, modified and deleted POPs at block 180. At block 182, the new POPs list is printed to a full phonebook tree with the new open version phonebook number, and at block 184 the delta files 164 are printed into a delta files tree. In one embodiment the phonebook and delta trees are stored at the web server 52.

All the files are associated with a version number in order to facilitate a more efficient update process described above.

The phonebook generation tool 60 utilizes “pricing” and “access point” data maintained in the access point and pricing databases 74 and 76 illustrated in FIG. 1B. The pricing data includes buy and sell prices for all access points. Sell prices for access points combined with a number of other pricing parameters constitute a “pricing plan”. Each phonebook, for which a record is maintained within the phonebook database 66, has a pricing plan associated therewith. Access point information includes all POP related information. When access point information is modified, this data is tagged with the latest “open” version number.

Methodology: Customization by the End-Users of the Customers

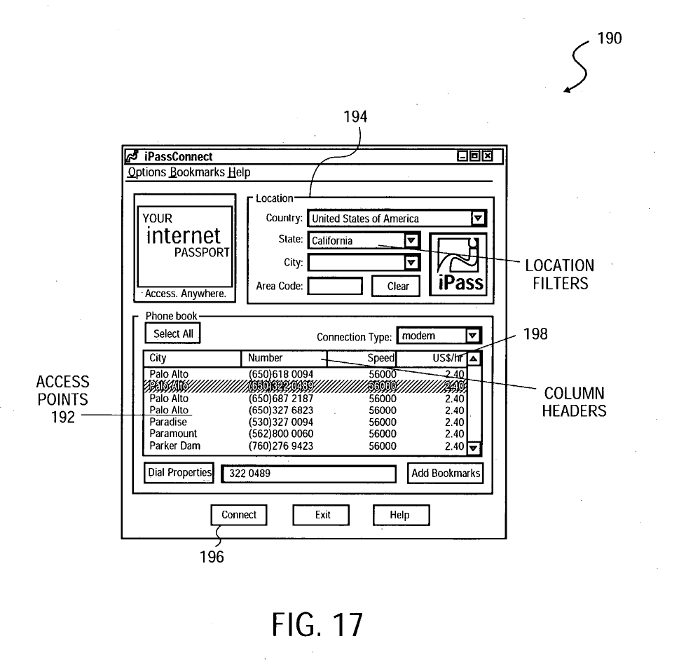

In one embodiment of the present invention, the end-user invokes a customized network connection application in the form of a dialer 186 on the client machine 188 of FIG. 16. FIG. 17 illustrates a main dialog box 190 of the customized dialer 186, according to one embodiment, that is presented to the end-user upon invocation of the dialer 186. To establish a dial-up connection the end-user may select an access point from the list of all the available access points presented to him/her in box 192. In order not to display the list of all available access points, most of which will be long distance calls, the end-user may enter his/her location in box 194. The customized dialer 186, in one embodiment of the present invention, filters the list of access points based on the end-user's location and displays only the closest points of access in box 192. Upon selection of an access point, the end-user may click on a connection button 196 in order to instruct the customized dialer 186 to establish a network connection via the selected access point. In one embodiment of the present invention, the access points displayed in box 192 may be sorted by city name. Alternatively, the end-user may sort the access points list by phone numbers, connection speed, or price by clicking on the corresponding column headings. For example, to sort by price the end-user may click on box 198.

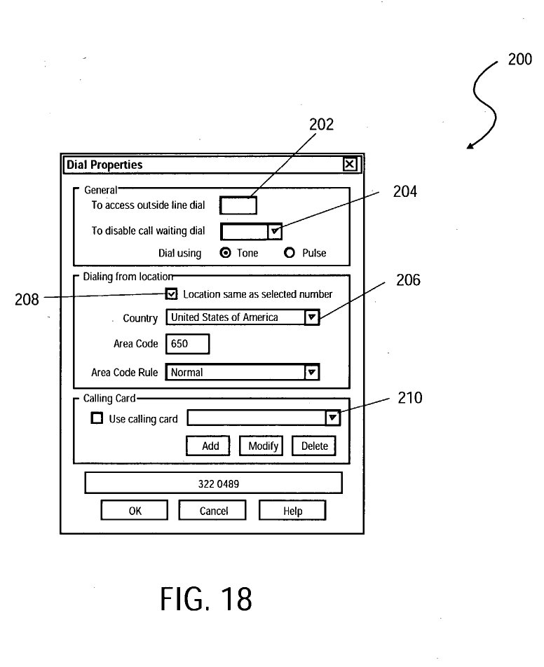

The end-user may specify the dialing settings to use by the customized dialer 186 when establishing a remote network connection. FIG. 18 illustrates an exemplary dial properties dialog box 200 that is presented to the end-user. Facilities using private branch exchange (PBX) (e.g., a private telephone network users of which share a number of outside lines), usually require an access code to obtain an outside line. Thus, in box 202, the end-user is prompted to enter an outside line code. Some phone lines are setup with a call waiting feature, which in one embodiment may need to be disabled prior to establishing a data connection. The end-user may enter in box 204 a phone number to dial in order to disable the call waiting feature. In box 206 the end-user may enter the country and area code from which the end-user is dialing; this information is used by the customized dialer 186 to determine if an area code, a country code or an access code need to be dialed in order to establish a network connection via the end-user-selected access point. In one embodiment, if check box 208 is checked by the end-user, the selected number will automatically be dialed as a local number. Calling card information may be entered in box 210 to be used when dialing the end-user-selected access point number. Each calling card may be defined by a name, access number, PIN and a dialing rule.

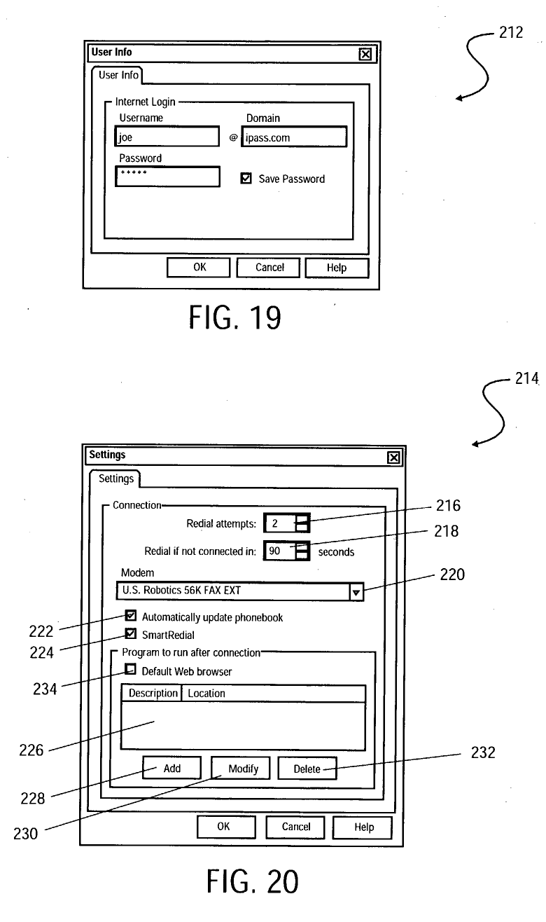

In order for the customized dialer 186 to establish the connection with the Internet, the end-user's information such as username, domain and password should be available. End-user information dialog box 212 illustrated in FIG. 19 prompts the end-user for such information. In one embodiment the end-user information dialog box 212 is automatically displayed if the end-user dials an access point without providing all the required end-user information.

The setting dialog box 214 illustrated in FIG. 20 allows the end-user, in one embodiment of the present invention, to specify settings used in establishing the remote connection. The end-user may specify in box 216 the number of redial attempts to be made by the customized dialer 186 when the network connection may not be established from the first dialing attempt. Alternatively, in box 218 the end-user may specify the duration of an attempt to establish the connection before redialing. For example, the end-user may desire for the customized dialer 186 to redial the same or different access point number if connection is not established within 90 seconds. Depending on the device used for the dial-up connection particular features of the customized dialer 186 may need to be invoked, thus the end-user may specify the dialing-up device that he/she may select from the drop down menu 220.

In one embodiment, the end-user may select an option of automatic update of the phonebook upon establishment of the network connection by check box 222. This will ensure that the latest network access numbers are used next time the end-user invokes the customized dialer 186. A “smart redial” option, when enabled by the end-user check box 224, directs the customized dialer 186 to dial another number in the same city when the dial-up attempt failed using the first network access number. In one embodiment the end-user may wish to run particular applications upon the establishment of the network connection, for example a Web browser, such as Internet Explorer™ (Microsoft Corporation). Instead of opening desired applications manually, the end-user may direct the customized dialer 186 automatically to launch specified applications when the network connection is established by adding software applications to box 226 utilizing Add 228, Modify 230 and Delete 232 buttons illustrated in FIG. 20. In another embodiment of the present invention, the end-user may select an option of launching a default web browser once the connection is established by checking on the Default Web Browser box 234.

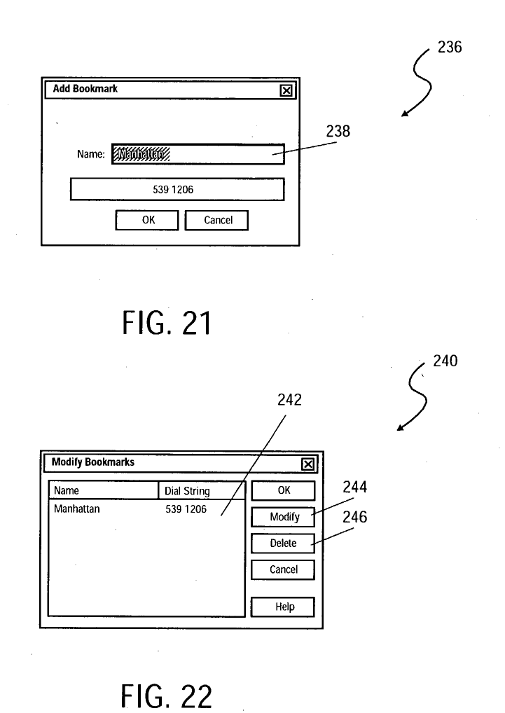

In one embodiment of the present invention, the end-user may bookmark the access points that are most often used. FIG. 21 illustrates an exemplary dialog box 236 that the end-user may use in order to compile a list of favorite network access points. Window 238 allows the end-user to add a bookmark by entering the location of the access point. FIG. 22 illustrates an exemplary dialog box 240 that an end-user may utilize to modify a list of favorite network access points. Window 242 allows the end-user to modify the list of bookmarks by providing a Modify option 244 to change the properties of a bookmark and a Delete option 246 to remove a bookmark from the list.

In one embodiment of the present invention, the end-user may access an online help feature from any dialog boxes described above by clicking on a Help button.

Some settings may be saved in the configuration files on the client machine 188 when the end-user exits the customized dialer 186. The saved settings may be location filters (country, state, city, area code), connection type (modem, ISDN), selected access points, dial properties including dialing prefixes, the location of the end-user and calling card information, end-user information including end-user name, domain name and password and modem settings including redial attempts, redial timeout, modem device, update phonebook selected options, SmartRedial, bookmarks and programs to launch after the connection is established.

Certain area codes in the Unites States require 10/11-digit dialing when placing calls within the area code. These dialing requirements are very regional and are constantly changing. In one embodiment of the present invention, a dialing rule file is downloaded to the client machine 188 along with the distribution of the customized dialer 186, containing all the area codes that require 10-/11-digit dialing.

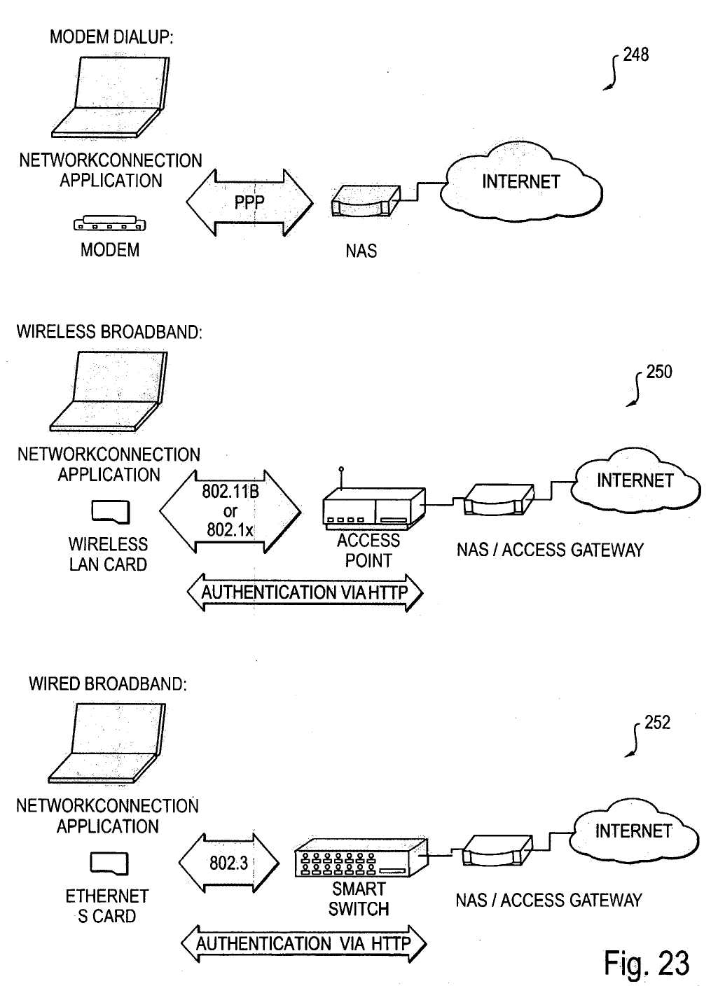

FIG. 23 is a diagrammatic representation of three exemplary protocols and hardware components of three exemplary access methods, supported by network connection applications according to respective exemplary embodiments of the present invention. Specifically, a modem dialup access method is illustrated at 248, a wireless broadband access method is illustrated at 250 and a wired broadband access method is illustrated at 252. As mentioned above, the present invention is not restricted to the generation, updating and distribution of a dialer for establishing a modem dialup connection, and extends to a method and system for generating, updating and/or distributing a network connection application for establishing a network connection between the two machines.

In the foregoing specification the present invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

Secure Updating of Connection Application

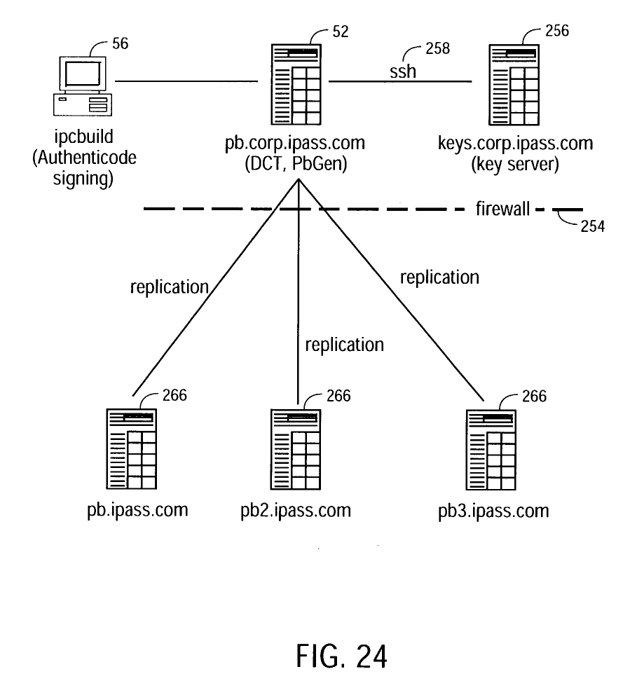

Returning in particular to FIGS. 1 and 16, files of the connection application (in the exemplary form of the dialer 186) that are loaded on the client machine 188 can be updated in a secure fashion, as described in more detail below. In one embodiment of the invention, as shown in FIG. 24, the web server 52, the database server 54, the build server 56 and the update server 58 are located behind a firewall 254. As described in more detail below, a key pair server 256 is also provided to generate private/public key pairs that are communicated to the web server 52 via a secure link 258. The key server 256 may be located on- or off-site.

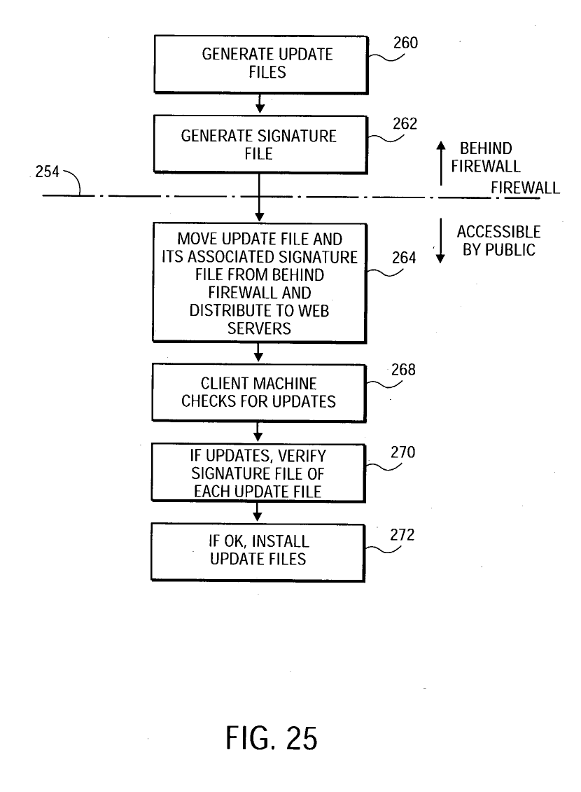

Referring in particular to FIG. 25, when an update file (e.g. client executable files, DLLs, phone book files, connection action executable files, device drivers, logo files, Windows service executable files, and the like) are generated (see block 260), the DCT and PbGen applications in web server 52 generates a signature file (see block 262) using a private key of a private/public key pair. As shown at block 264, the update file and its associated signature file are then replicated to the web servers 266 that are accessible by remotely located users via a network, e.g. the Internet. The client machine 188 then checks for file updates (see block 268), and in the event of there being updates, the dialer 186 verifies a signature file associated with the file update, as shown at block 270. If the signature file is valid, then the update file is installed as shown at block 272. Thus, the read-only copies of the updated files and their signatures generated by DCT and PbGen in web server 52 are then replicated to the web servers 266 for communication to the client.

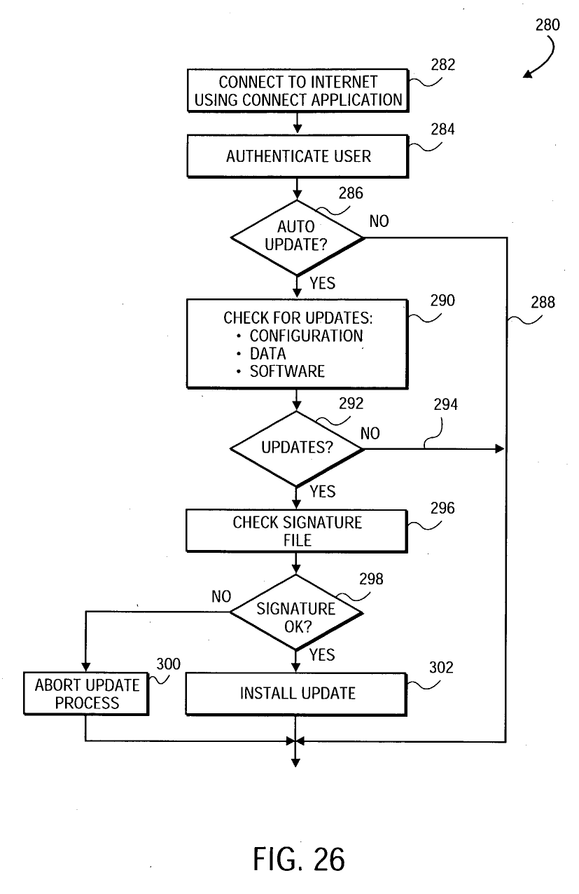

Referring to FIG. 26, reference numeral 280 generally indicates a method, in accordance with one embodiment of the invention, performed by a client application in the exemplary for of the dialer 186. As mentioned above, the dialer 186 may allow a user to connect to the Internet from anywhere in the world. As shown at block 282, in order to do so, a user may specify an access-type, user credentials (e.g., a user id and a password) and a location from an intuitive user interface generated by the dialer 186, and select a local connection point (see exemplary dialog box 200 of FIG. 18). Once the client machine 188 is connected to the Internet, the dialer 186 authenticates the user as shown at block 284. The dialer 186 then checks to determine if its automatic update feature has been selected (see decision block 286) and, if not, the update functionality is skipped as shown by line 288. If, however, the automatic update feature has been selected, the dialer 186 checks for configuration, data and software updates as shown at block 290. In one embodiment, the dialer 186 uses HTTPS protocol to check for, as well as obtain, updated files from the web server the user has selected. If no updates are present then, as shown at decision block 292, the update functionality is skipped (see line 294).

Returning to decision block 292, in the event of their being file updates, the dialer 186 then at block 296 checks or verifies the signature file associated with each updated file and, if the signature file fails the verification process (see block 298), the update routine is aborted as shown at block 300. If, however, the signature is positively verified, then the update file is downloaded and installed on the client machine 188 as shown at block 302. Thus, if the security of a DNS or the phonebook server is compromised, e.g. an attacker with devious intent has loaded arbitrary virus infected software on the server, the dialer 186 may, during an update procedure, reject the update as the update would fail the signature file verification test at block 296.

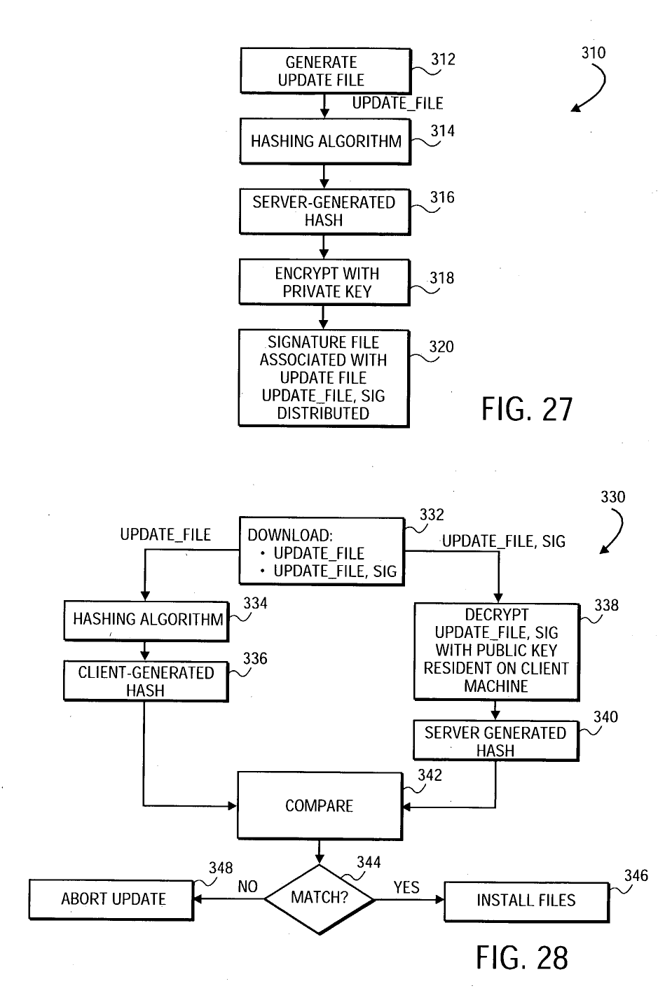

An exemplary method of generating a signature file is generally indicated by reference numeral 310 in FIG. 27. The method may be executed by the DCT and PbGen applications in web server 52 and begins by generating the update file (e.g. client executable files, DLLs, phone book files, connection action executable files, device drivers, logo files, Windows service executable files, and the like) as shown at block 312 to produce an exemplary file Update_File which is fed into a hashing algorithm at block 314 to produce a server-generated hash uniquely associated with the Update_File (see block 316). The server-generated hash is then encrypted (see block 318) with a current private key of a current private/public key pair generated by the key server 256 (see FIG. 24). The update file and its associated signature file are then distributed to the web servers (see block 266 of FIG. 24).

Reference numeral 330 generally indicates an exemplary method, in accordance with one embodiment of the invention, for verifying an update file using its associated signature file that have both been downloaded (see block 332) by the client machine 188. As described in more detail below, the method includes generating a local signature file and comparing the local signature file to the downloaded signature file after it has been decrypted.

In particular, as shown at block 334, when the dialer accesses any one of the web servers 266 in order to check for updates, it checks for one or more update files that it may require. If an update file is identified (e.g. Update_File), it is then downloaded from the web server 266 and fed through a local copy of the same hashing algorithm used by the DCT and PbGen applications in web server 52 (see block 314 in FIG. 27) to obtain a client-generated hash, as shown at block 336. It will be appreciated that, as the same hashing algorithm is used at both the client machine 188 and the web server 52, the client-generated hash (see block 336) and server-generated hash (see block 316) will be identical unless the update file has been tampered with.

Returning to block 332, the signature file associated with the update file (e.g. Update_File.sig) is decrypted by the dialer 186 using the public key as shown at block 338 to provide the server-generated hash (see block 340 in FIG. 28 and block 316 in FIG. 27). As shown at block 342 the client-generated hash (see block 336) and the server-generated hash (see block 340) are then compared to verify that the update file has not been tampered with. If the client-generated hash and the server-generated hash match (see decision block 344) then the update file is installed on the client machine 188 thereby to update the dialer 186 (see block 346). If, however, the client-generated hash and the server-generated hash do not match then the update process for the particular update file is aborted as shown at block 348. The aforementioned method may be applied to a plurality of different update files identified by the dialer 186 when accessing any one of the web servers 266. Thus, the dialer 186 can cryptographically ensure that it only installs dialer or connect components and phonebooks that were generated by a trusted party.

In one embodiment of the invention, the dialer 186 on the client machine 188 includes a variety of files including client executable files, dynamic Link Libraries (DLLs), phonebook files, configuration files, connect action executable files, device drivers, logo files, and windows service executable files. As mentioned above, the customization tool 62 may build a self-extracting installer executable that includes all the customized options and associated files. In one embodiment, the installer or agent is delivered to customers who in turn distribute them to their end-users who install a customized connection application in their computers by executing the self-extracting installer executable. If the security of any remote web server 266 including the update files is compromised, using, the exemplary method in accordance with the invention, the integrity of the files being updated by dialer 186 is not compromised because the attacker cannot generate the corresponding signature files required by dialer 186 without access to the private key. In one embodiment, only trusted users are given access in a secure fashion to the key server 256.

In one embodiment, once the update files and their associated signature files have been generated by the DCT and PbGen applications in web server 52, replication is used to distribute changes from the web server 52, which is behind the firewall 254, to the web servers 266. The web servers 266 may be public web servers located at various points around the globe that may be accessed directly by a dialer 186 on a client machine 188. In one embodiment, replication operates asynchronously from the web server 52 (that may include the customization tool 62 and the phonebook generation tool 60) so that there are no interdependencies between when the web server 52 generates files and when they are replicated. Any temporary discrepancies may be gracefully handled by the dialer 186 by ignoring the update.

The private/public key pair may be periodically updated. In order to obtain a private key from the key server 256 in a secure fashion, the web server 52 may use SSH credentials. An updated public key may then be distributed to the dialer 186, as discussed in more detail below. An exemplary logical view of the system 50, when configured for secure updating, is set out in an exemplary Table 1 set out below. The web server 52 may store information about the files that are signed in Table 1. Each customer may have a customized dialer profile that uses a common phonebook 350 (see FIG. 16). Accordingly, in one embodiment, table entries may be provided for each customer profile generated by the customization tool 62, and a single record may be generated for the entire phonebook 350 that is generated by the phonebook generation tool 60. Files manually signed may also be recorded in Table 1.

TABLE 1
signature_log

| | | Unique identifier, |
|---|---|---|
| signature_log_id | Number | generated by sequence. |
| ##Filename | Varchar2(1024) | The name of the file that |
| | | was signed. |
| modification_time | Date | The last modified time of |
| | | the file |
| signature_time | date | Time that the file was |
| | | signed. |
| Owner | Varchar2(64) | Owner of the file |
| Signer | Varchar2(64) | The user who signed the |
| | | file. |
| comment | Varchar2(1024) | Comment field (e.g. |
| | | phonebook) |

In certain embodiments, various tools may be implemented to sign the update files for the dialer 186 and generate new public/private key pairs. In one embodiment, the signing tools may reside on the web server 52 for signing files created by the dialer customization tool 62 and the phonebook generation tool 60, while the key generation tool may reside on key server 256, where the public/private key-pairs are generated and maintained.

Web Server 52

As mentioned above, the web server 52 replicates updated files from behind the firewall 254 (see FIG. 24) to web servers 266 that host the update files. In certain embodiments, a new class signature is implemented for signing files from Java applications on the web server 52. This class signature may be used by the customization tool 62 and the phonebook generation tool 60, and may also support the creation of an interactive tool for signing arbitrary files.

An exemplary class utility signature routine (SignFiles) is as follows:

public class Signature {

/**

* Signs files by creating corresponding .sig files. This method may only

* sign files that need to be signed (e.g., a .sig file is missing, or has a

* newer timestamp than the .sig file). If the sync flag is true, SignFiles

* will lock a semaphore, sign the files, then launch the synchronization

* process. SignFiles will wait for the synchronization process to complete

* then release the lock on the semaphore.

* @param fileList array of files to sign

* @param username username for ssh access to key server

* @param password password for ssh access to key server

* @param comment text to be stored in comment field in db

* @param logMode log into signature_log table

* 0=don't log

* 1=log once for entire list

* 2=log for each file in list

* @param signMode 0=don't sign, just check if credentials are valid

* 1=sign with current key

* 2=sign with all key versions

* @param sync true—launch synchronization program hook

* false—don't launch synchronization program hook

* @returns 0=success

* 1=failure, see event log table for details

* 2=failure, semaphore is not available

*/

public int SignFiles(String fileList[ ], String username, String password, String comment, int logMode, int signMode, bool sync) {

// This method will use ssh to retrieve the private key from the key server,

// then use JNI to call the OpenSSL signing functions. The signing function

// uses sha1 for the message digest algorithm.

}

/**

* Interactive tool for signing files. At startup, the program will prompt

* for username, password and pass-phrase to access private key.

* Then the program will prompt for each file to be signed.

*/

public static void main(String args[ ]) {

}

}

Key Server 256

As mentioned above, the key server 256 may generate keys to cryptographically sign the update files. In one embodiment, the key server 256 generates an RSA 1024 bit private key and its corresponding public key. For example, the update files may be signed by a public key identified as pubkey.pem, using SHA1 message digest algorithm, and outputs the signature to filename.sig (as discussed above).

In certain embodiments, the keys are placed into an exemplary /usr/local/secure_update/keys/current directory, as shown in Table 2 below.

TABLE 2

| Directory | Description |
|---|---|
| /usr/local/secure_update | Top level directory for secure |
| | update files. |
| /usr/local/secure_update/bin | Signing tools directory, |
| | including programs supplied by |
| | OpenSSL. |
| /usr/local/secure_update/keys | Keys directory. |
| /usr/local/secure_update/keys/ | Directory for current key used |
| current | for signing. |
| /usr/local/secure_update/keys/1 | Directory for previous keys, |
| /usr/local/secure_update/keys/2 | which are used when changing |
| /usr/local/secure_update/keys/3 | the current key pair. The public |
| | and private keys may be named |
| | pubkey.pem and prvkey.pem. |

Private Key Retrieval

A private key for signing update files may be retrieved from the key server 256 using an exemplary program get_private_key, set out below. The get_private_key program may be executed on the key server 256 by the SignFiles method from the web server 52 via SSH, as described above. The output of the private key may be sent to standard output, which can be easily read by the SignFiles method that invoked the SSH.

The exemplary program usage may be as follows:

Usage: get_private_key [−v key_version] [−p pass-phrase]

In one embodiment, the default behavior of the system 50 may be to retrieve the private key from a location /usr/local/secure_update/keys/current/prvkey.pem. If the key_version is supplied, a previous version of the key can be retrieved. The pass-phrase must be supplied if the key is protected by a pass-phrase. If the key version or pass-phrase supplied by the user is invalid, the utility will return nothing to the standard out.

Methodology: Updating Key Files

As mentioned above, in certain embodiments, the encryption keys and/or encryption algorithms may be updated. When the private keys used for signing the update files are updated, the following exemplary functionality (described in more detail later in this document) may be performed on the key server 256 to allow for a transition during which existing dialers 186 may still use old public keys:

1) Create a new directory /usr/local/secure_update/keys/n, where n is the next available number in the keys directory.

2) Move the files pubkey.pem and prvkey.pem from the keys/current directory to keys/n directory.

3) Using OpenSSL, generate the new key files pubkey.pem and prvkey.pem into the directory keys/current.

The following steps may be performed on the web server 52:

1) Increment the key version information in key.ver.

2) Copy over pubkey.pem from the key server to $docroot/version/key/key.ver

3) Run the SignFiles tool, signing key.ver and pubkey.pem with all previous keys.

Using the above exemplary functionality, updated keys may be provided to sign update files for distribution to any one or more dialers 186 via a web server 266.

Connection Application

In order to authenticate update files that are downloaded, and thus enable a secure update of existing files, the config.ini file on the client machine 188 may have the following exemplary configuration setting:

[Profile]

SecureUpdate=yes

In certain embodiments, if secure updating is enabled (SecureUpdate=yes), and the public key file (e.g., pubkey.pem) exists on the client machine 188, the dialer 186 may verify the signature of an update file identified for downloading. However, if the public key file does not exist or if secure updating is disabled (SecureUpdate=no), the update process may be aborted.

As described above, the dialer 186 may check with the web server 52 to determine if a file update has a corresponding signature file and, if the signature of any file fails to match or does not exist (see FIG. 26), the entire update for may be silently discarded and the update process may be aborted. In certain embodiments, an error message may be recorded into an update.log to indicate the nature of the failure. The update file may be identified by a version number and may relate specifically to a particular customer (e.g., profile.ver) or relate to all customers (e.g., global.ver).

In certain embodiments, if a signature file, corresponding to a particular update file, is located on the web server 52, the signatures are verified (see FIG. 28) and the dialer 186 may continue to copy all files to an appropriate application directory on the client machine 188.

Exemplary pseudo-code for handling of the exemplary profile.ver and global.ver files is as follows:

download and authenticate version file

determine file set to be downloaded (identify if there are updates)

for each file in file set

download and authenticate file

for each file in file set

install downloaded files

Methodology: Updating Public Key File

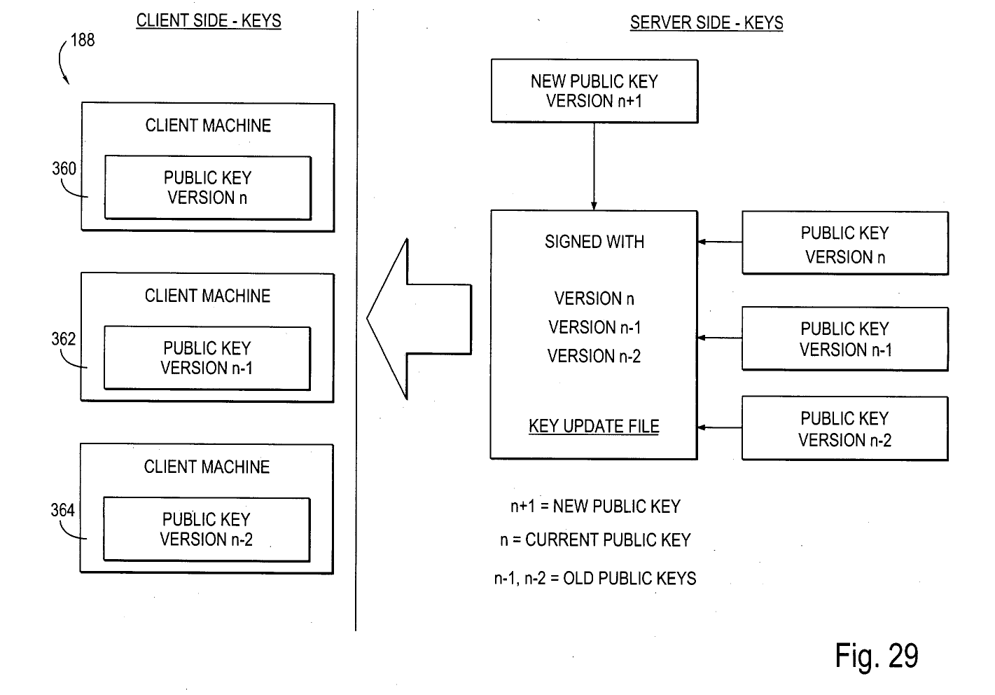

In one embodiment, the web server uses a current private key of a current private/public key pair to generate the signature files. However, circumstances may arise, as shown in FIG. 29, in which dialers 186 distributed to users may have older or previous versions of a public key file (e.g. pubkey.pem). Although these may be older versions of the public key file, the system 50 may still consider them as valid thus allowing the system 50 to “migrate” encryption keys. This may provide a plurality of encryption keys that overlap in their validity period.

Referring in particular to FIG. 29, an example is shown where three different client machines 188 each have a different version of the public key file (and thus public key). For example, a client machine 360 may have a public key version n, a client machine 362 may have a public key version n−1, and a client machine 364 may have a public key version n−2, wherein n represents the current version, n−1 represents an older version, and n−2 represents the oldest version. Thus, in one embodiment where the dialer 186 receives an update file and its associated signature file generated using the current private key (e.g. private key version n corresponding to public key version n), the dialers 362 and 364 that have older key versions may be unable to verify the signature files and, accordingly, may thus not install any update files. Thus, in certain embodiments of the system 50, the public keys (versions n−1 and n−2) may need to be updated.

In certain embodiments, the public key files (and thus the public keys) may be updated in a different manner to standard files (e.g., client executable files, DLLs, phonebook files, configuration files, connect action executable files, device drivers, logo files, Windows Service executable files, or the like). In one embodiment, the web server 52 maintains a record of the older key pairs (see Table 2 above).

When a dialer 186 does not have a current public key (e.g., the dialers on client machines 362 and 364) it may thus be unable to verify a signature file (see block 338 of FIG. 28). In one embodiment, in order to permit key updating, the web server 52 generates a signature file (e.g., as described above) for the current public key file (and thus the current public key) which may replicated to the web servers 266 for downloading by the dialers 188. As the dialers 186 may have older versions of the public key (e.g., the dialers on client machines 362 and 364), the current public key file (which may thus define an update file) has a signature file corresponding to each of the old public keys (versions n−1 and n−2) that are still valid.

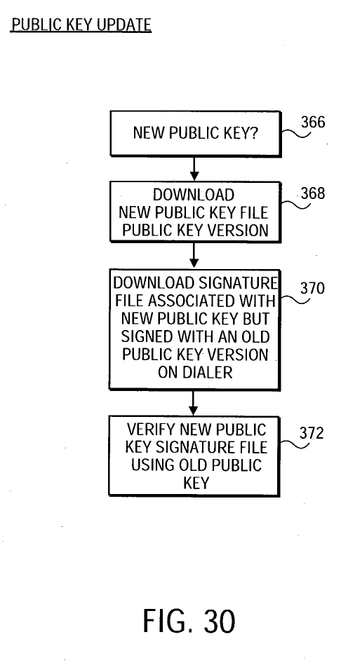

When the dialer 186 identifies that there is a new current public key (see block 366 in FIG. 30), the dialer 186 may download the new or current public key file, as shown in block 368, along with its signature file that corresponds to its existing public key (e.g. the client machine 364 may download the signature file associated with public key version n−2), as shown in block 370. Thus, when the dialer 186 verifies (see block 372) the signature file associated with the current public key (see FIG. 28), the same public key is used for encryption (see block 318 in FIG. 27) and decryption (see block 338 in FIG. 28).

As a further example, if the dialer 186 has a public key pubkey.pem (version 1) and has not updated itself for some time, the dialer update process may include a public key version 4 (the fourth public key generated). Public key version 4 may have signature files: “pubkey.pem.sig.1”, “pubkey.pem.sig.2”, “pubkey.pem.sig.3” corresponding to the new key signed by previous key values. In this case, dialer 186 must verify the signature file pubkey.pem.sig.1, which corresponds to its known good version of the public key.

As discussed above, the update files for updating the dialer 186 are secured using a public/private key combination obtained from the key server 256. However, the self-extracting installer, which is generated by the customization tool 62, may be signed using Microsoft's Authenticode technology.

Unlike the dialer 186, which authenticates files it downloads by using a separate signature file, Authenticode incorporates a digital signature directly into executable files. Installers are often downloaded using Internet Explorer, which can only validate signatures generated with Authenticode. Further, as Authenticode can only be used on certain file types (e.g. exe and DLL files), the dialer 186 uses its own authentication method for processing files such as phonebooks, scripts and configuration files.

Phonebook Generation Tool 160

In certain embodiments, the phonebook generation tool 60 may accept user credentials for retrieving the private key from the key server 256 for signing the phonebook files. In these embodiments, the phonebook generation tool 60 may check to ensure that the credentials provided are valid before it proceeds to start the phonebook generation process. This may avoid the scenario where the phonebook generation tool 60 may, for example, be started and running for many hours before it tries unsuccessfully to obtain a private key for signing from the key server 256.

In one embodiment, when phonebook generation tool 60 is started in a “test” mode, all files created may be added to an array to be passed to the SignFiles method. When phonebook generation tool 60 is started in a “publish” mode, after moving the files, the global.ver is edited and thereafter signed.

A version (key.version) file may be provided on the web server 52 in a $docroot/version/ver.win/key.ver. The version file may include the following information:

pubkey.pem,k,1,0,0,key,,0,0,0,0

In one embodiment, the key version ile may be retrieved by the dialer 186 only when there is an authentication error, in case the public key has changed. The attribute ‘k’ may indicate that this is a key file, which requires special processing by the dialer 186 during an update. During the update process, the client dialer 186 may contact the web server 266 and retrieve the list of files and their latest version numbers that have been replicated from the web server 52 behind the firewall 254. The dialer 186 may compare the list of files stored locally with the list retrieved from the web server 266. If the list and/or the version numbers do not match, the dialer 186 may retrieve the affected files from the web server 266. In one embodiment of the present invention, the build executable and DLL files are downloaded to the client machine 188 and stored in temporary locations due to the possible inefficiency of updating dialer files when the dialer 186 is running (the user may be using the network connection). Upon the end-user terminating the connection to the network, the files on the client machine 188 may be replaced with the updated files, for example, containing newer information.

In one embodiment, the customer may not want the end-users to have access to the latest changes until, for example, the testing of all new POPs is performed. In such a case, the customer may instruct the system 50 not to update its associated dialers 186 automatically unless instructed otherwise.

Computer System

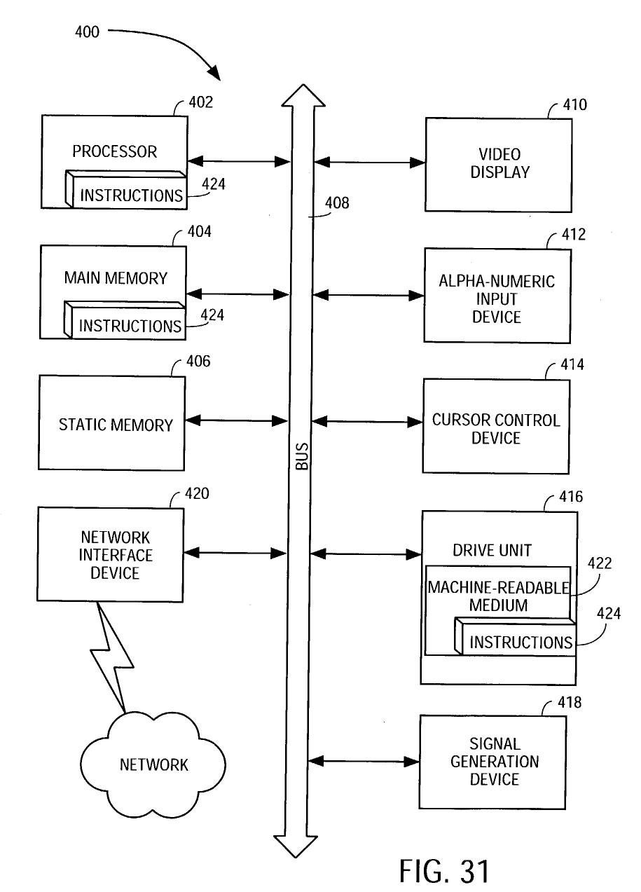

FIG. 31 is a diagrammatic representation of a machine in the form of computer system 400 within which software, in the form of a series of machine-readable instructions, for performing any one of the methods discussed above may be executed. The computer system 400 includes a processor 402, a main memory 404 and a static memory 406, which communicate via a bus 408. The computer system 400 is further shown to include a video display unit 410 (e.g., a liquid crystal display (LCD) or a cathode ray tube (CRT)). The computer system 400 also includes an alphanumeric input device 412 (e.g., a keyboard), a cursor control device 414 (e.g., a mouse), a disk drive unit 416, a signal generation device 418 (e.g., a speaker) and a network interface device 420. The disk drive unit 416 accommodates a machine-readable medium 422 on which software 424 embodying any one of the methods described above is stored. The software 424 is shown to also reside, completely or at least partially, within the main memory 404 and/or within the processor 402. The software 424 may furthermore be transmitted or received by the network interface device 420. For the purposes of the present specification, the term “machine-readable medium” shall be taken to include any medium that is capable of storing or encoding a sequence of instructions for execution by a machine, such as the computer system 400, and that causes the machine to perform the methods of the present invention. The term “machine-readable medium” shall be taken to include, but not be limited to, solid-state memories, optical and magnetic disks, and carrier wave signals.

If written in a programming language conforming to a recognized standard, the software 424 can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine, such as the computer system NOO, the machine to perform an action or a produce a result.

The preceding description of FIG. 31 is intended to provide an overview of computer hardware and other operating components suitable for implementing the invention, but is not intended to limit the applicable environments. One of skill in the art will immediately appreciate that the invention can be practiced with computer architectures and configurations other than that shown in FIG. 31, including hand-held devices, multiprocessor systems, microprocessor-based or programmable consumer electronics, network PCs, minicomputers, mainframe computers, and the like. A typical computer system will usually include at least a processor, memory, and a bus coupling the memory to the processor. The invention can also be practiced in distributed computing environments where tasks are performed by remote processing devices that are linked through a communications network.

In the foregoing specification the present invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A method of updating a client file in a multi-party access environment including a plurality of web servers, the method including:
generating at least one customized client update file, the client update file being customized for a client application of at least one of a plurality of users in the multi-party access environment;
generating a secured signature file associated with the client update file;
communicating the secured signature file and the client update file to the plurality of web servers;
downloading the secured signature file and the client update file;
verifying the secured signature file; and
selectively installing the client update file in response to the verification.

2. The method of claim 1, wherein generating the secured signature file includes:
passing the client update file through a hashing algorithm to produce a server-side hash; and
encrypting the server-side hash with a private key thereby to define the secured signature file associated with the client update file.

3. The method of claim 1, wherein the client update file includes at least one of an Executable file, a Dynamic Link Library (DLL), a phonebook file, a configuration file, a file defining connection action executables, a device driver, a logo file, and a Windows Service executable file.

4. The method of claim 1, wherein the client file is for a connection application for connecting a client machine to a service access provider.

5. A method of updating a customized client application of at least one of a plurality of users in a multi-party environment, the method including:
generating at least one customized client update file, the client update file being provided to remotely update the customized client application;
obtaining a private/public key pair;
securing the client update file with a private key of the key pair; and
communicating the secured client update file to the customized client.

6. The method of claim 5, in which securing the client update file includes:
generating a secured signature file associated with the client update file; and
communicating the secured signature file and the client update file to the customized client application.

7. The method of claim 6, in which generating the secured signature file includes:
passing the update file through a hashing algorithm to generate a server-side hash; and
encrypting the server-side hash with the private key to provide the secured signature file associated with the client update file.

8. The method of claim 7, in which the client update file includes at least one of a public key, an Executable file, a Dynamic Link Library (DLL), a phonebook file, a configuration file, a file defining connection action executables, a device driver, a logo file, and a Windows Service executable file.

9. The method of claim 6, in which the client application is a connection application to provide roaming Internet access to the user.

10. The method of claim 6, which includes replicating the client update file and the secured signature file from behind a firewall to a plurality of web servers—that are accessible to the public.

11. The method of claim 6, wherein the public key defines an old public key, the method including:
providing an updated public key in the form of the client update file; and
generating a secure signature file which is encrypted with the private key corresponding to the old public key.

12. The method of claim 11, which includes generating a plurality of signature files that are all associated with the client update file providing the updated public key, each update file being encrypted with a different old version of a private key corresponding to an old version of the public key.

13. A method of updating a client application on a client machine, the method including:
establishing a connection with an access server of an access service provider;
determining if a client update file associated with the client application is provided by the access server;
selectively downloading the client update file from the access server when the client update file is present;
verifying the validity of the client update file; and
selectively installing the client update file on the client machine.

14. The method of claim 13, in which verifying the validity of the client update file includes:
downloading a secured signature file associated with the client update file; and
verifying the validity of the secured signature file thereby to verify the validity of the client update file.

15. The method of claim 14, in which verifying the signature file includes:
passing the client update file through a hashing algorithm corresponding to a server-side hashing algorithm thereby to generate a client-side hash;
decrypting the secured signature file using a public key to obtain a server-side hash; and
comparing the client-side hash with the server-side hash.

16. The method of claim 15, which includes installing the update file if the client-side hash and the server-side hash match.

17. The method of claim 15, which includes checking for an update file associated with a new public key when the client-side hash and the server-side hash do not match.

18. The method of claim 15, which includes:
identifying a secured signature file that has been encrypted with a private key corresponding to the public key of the client application; and
replacing the public key of the client application with an updated public key provided in the client update file if the client-side hash and the server-side hash match.

19. The method of claim 13, wherein the client application is a connection application and the update file is one of an Executable file, a Dynamic Link Library (DLL), a phonebook file, a configuration file, a file defining connection action executables, a device driver, a logo file, and a Windows Service executable file.

20. The method of claim 13, wherein the client application is a connection application to provide roaming Internet access to a user.

21. A machine-readable medium embodying a sequence of instructions that, when executed by a machine cause the machine to execute a method of updating a customized client application of at least one of a plurality of users in a multi-party environment, the method including:
generating at least one customized client update file, the client update file being provided to remotely update the customized client application;
obtaining a private/public key pair;
securing the client update file with a private key of the key pair; and
communicating the secured client update file to a plurality of web servers for downloading by a user.

22. The machine-readable medium of claim 21, in which securing the client update file includes:
generating a secured signature file associated with the client update file; and
communicating the secured signature file and the client update file to the plurality of web servers.

23. The machine-readable medium of claim 22, in which generating the secured signature file includes;
passing the update file through a hashing algorithm to generate a server-side hash; and
encrypting the server-side hash with the private key to provide the secured signature file associated with the client update file.

24. The machine-readable medium of claim 23, in which the client update file includes at least one of a public key, a Executable file, a Dynamic Link Library (DLL), a phonebook file, a configuration file, a file defining connection action executables, a device driver, a logo file, and a Windows Service executable file.

25. The machine-readable medium of claim 22, in which the client application is a connection application to provide roaming Internet access to the user.

26. The machine-readable medium of claim 22, in which the method includes replicating the client update file and the secured signature file from behind a firewall to the plurality of web servers.

27. The machine-readable medium of claim 22, wherein the public key defines an old public key, the method including:
providing an updated public key in the form of the client update file; and
generating a secure signature file which is encrypted with the old public key.

28. The machine-readable medium of claim 27, wherein the method includes generating a plurality of signature files that are all associated with the client update file providing the updated public key, each update file being encrypted with a different old version of a private key corresponding to an old version of the public key.

29. A machine-readable medium embodying a sequence of instructions that, when executed by a machine, cause the machine to execute a method of updating a client application on a client machine, the method including:
establishing a connection with an access server of an access service provider;
identifying if a client update file associated with the client application is provided by the access server;
selectively downloading the client update file from the access server when the client update file is present;
verifying the validity of the client update file; and
selectively installing the client update file on the client machine.

30. The machine-readable medium of claim 29, in which verifying the validity of the client update file includes:
downloading a secured signature file associated with the client update file; and
verifying the validity of the secured signature file thereby to verify the validity of the client update file.

31. The machine-readable medium of claim 30, in which verifying the signature file includes:
passing the client update file through a hashing algorithm corresponding to a server-side hashing algorithm thereby to generate a client-side hash;
decrypting the secured signature file using a public key to obtain a server-side hash; and
comparing the client-side hash with the server-side hash.

32. The machine-readable medium of claim 31, wherein the method includes installing the update file if the client-side hash and the server-side hash match.

33. The machine-readable medium of claim 31, wherein the method includes checking for an update file associated with a new public key when the client-side hash and the server-side hash do not match.

34. The machine-readable medium of claim 31, wherein the method includes:
identifying a secured signature file that has been encrypted with a private key corresponding to the public key of the client application; and
replacing the public key of the client application with an updated public key provided in the client update file if the client-side hash and the server-side hash match.

35. The machine-readable medium of claim 29, wherein the client application is a connection application and the update file is one of an Executable file, a Dynamic Link Library (DLL), a phonebook file, a configuration file, a file defining connection action executables, a device driver, a logo file, and a Windows Service executable file.

36. The machine-readable medium of claim 29, wherein the client application is a connection application to provide roaming Internet access to a user.

37. A computer system to update a customized client application of at least one of a plurality of users in a multi-party environment, the system including:
an update server to generate at least one customized client update file, the client update file being provided to remotely update the customized client application, the client update file being secured with a private key of the a private/public key pair; and
a communication server to communicate the secured client update file to a plurality of web servers for downloading by a user.

38. The system of claim 37, in which the client update file is secured by generating a secured signature file associated with the client update file, the communication server communicating the secured signature file and the client update file to the plurality of web servers.

39. The system of claim 38, in which the secured signature file is generated by passing the update file through a hashing algorithm to generate a server-side hash, and encrypting the server-side hash with the private key to provide the secured signature file associated with the client update file.

40. The system of claim 39, wherein the client update file includes at least one of a public key, an Executable file, a Dynamic Link Library (DLL), a phonebook file, a configuration file, a file defining connection action executables, a device driver, a logo file, and a Windows Service executable file.

41. The system of claim 38, wherein the client application is a connection application to provide roaming Internet access to the user.

42. The system of claim 38, in which the communication server replicates the client update file and the secured signature file from behind a firewall to the plurality of web servers that are accessible to the public.

43. The system of claim 38, wherein the public key defines an old public key, the update server providing an updated public key in the form of the client update file, and generating a secure signature file which is encrypted with the old public key.

44. The system of claim 43, wherein the update server generates a plurality of signature files that are all associated with the client update file providing the updated public key, each update file being encrypted with a different old version of a private key corresponding to an old version of the public key.

45. A computer system to update a customized client application of at least one of a plurality of users in a multi-party environment, the system including: means to generate at least one customized client update file, the client update file being provided to remotely update the customized client application, the client update file being secured with a private key of the private/public key pair; and means to communicate the secured client update file to a plurality of web servers for downloading by a user.
